(19) United States
(12) Patent Application Publication
(10) Pub. No.: US 2011/0083072 A1
(43) Pub. Date: Apr. 7, 2011

(54) SYSTEM AND METHOD FOR USER-ADAPTABLE INTERFACE PRESENTATION FOR DOCUMENT PROCESSING DEVICES

(76) Inventor: Alok MATHUR, Rancho Santa Margarita, CA (US)

(21) Appl. No.: 12/818,196

(22) Filed: Jun. 18, 2010

Related U.S. Application Data
(60) Provisional application No. 61/249,418, filed on Oct. 7, 2009.
(60) Provisional application No. 61/249,683, filed on Oct. 8, 2009.

(51) Int. Cl. G06F 3/048; G06F 17/21

(52) U.S. Cl. 715/269; 715/833; 715/765; 715/810

(57) ABSTRACT

The subject application is directed to a document processing device and a system and method for generation of user-adaptable interface presentations on the document processing device. A visual output associated with the operation and the status of the document processing device is generated on a display of the device that is operated in conjunction with an integrated controller that includes a processor and associated data storage. User-specified instructions, corresponding to a display for operation of the document processing device, are then received and one or more visual indicators corresponding to a user-selectable display attribute are generated on the display. Any user-specified display modification instructions are then received. The modification instructions correspond to a desired modification to the visual output based upon the displayed visual indicator. The visual output is then altered using the received user-specified display modification instructions.

### CROSS-REFERENCE TO RELATED APPLICATIONS

This application claims priority to U.S. Provisional Patent Application Ser. No. 61/249,418, filed on Oct. 7, 2009 titled “SYSTEM AND METHOD TO ALLOW USER TO CHANGE THEME (COLOR SCHEME) OF MFP FRONT PANEL”, and U.S. Provisional Patent Application Ser. No. 61/249,683, filed on Oct. 8, 2009 titled “SYSTEM AND METHOD TO ALLOW USER TO CHANGE TEXT FONT SIZE FOR ACCESSIBILITY”, the entirety of which are incorporated herein.

### BACKGROUND OF THE INVENTION

The subject application is directed generally to adaptation of user interface depictions on displays in accordance with a user selection. The application is particularly applicable to user-customized font size or presentation schemes for document processing devices that allow for improved, subjective user control during document processing activities.

Modern document processing devices include printers, scanners, copiers, facsimile machines, and e-mail gateways. In office environments, devices frequently include two or more of these functions, and are referred to as multifunction peripherals (MFPs) or multifunction devices (MFDs). Power devices, such as MFPs, frequently included an embedded computer, referred to as a controller. This computer functions to allow for performing varied, complex operations by the MFP. It also generates a user-interface, such as on a display screen. User selection of control options includes performing one or more of the operations noted above on one or more selected documents. Further information secured from the user controls include items such as finishing options including duplex, simplex, hole-punching, collation, stapling, or the like. User-supplied information also may include an e-mail address, file selection for storage or retrieval, or entry of facsimile destination information.

Since MFPs are expensive to purchase and maintain, they are often shared by many users, and are frequently placed in networked data communication with other data devices, including workstations, servers, or other document processing devices. Devices typically have a standard interface, such as standard color scheme or a standard type font, for all users. However, some users may have poorer eyesight making it difficult to read information on the display to allow for use of the device. Still other users may be color blind in varying degrees or of varying types, such that they are unable to distinguish icons or characters on a display given relative coloration between foreground and background.

### SUMMARY OF THE INVENTION

In accordance with one embodiment of the subject application, there is provided a document processing device, system, and method for generating a user-adaptable interface presentation on a document processing device. A visual output associated with operation and status of the document processing device is first generated on a display of the device that is operated in conjunction with an integrated controller that includes a processor and associated data storage. User-specified instructions are then received, which correspond to a display for operation of the document processing device. One or more visual indicators corresponding to a user-selectable display attribute are then generated on the display. User-specified display modification instructions are then received that correspond to a desired modification to the visual output in accordance with the displayed visual indicator. Thereafter, the visual output is altered based upon received user-specified display modification instructions.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for generating a user-adaptable interface presentation on a document processing device according to one embodiment of the subject application;

FIG. 2 is a block diagram illustrating device hardware for use in the system for generating a user-adaptable interface presentation on a document processing device according to one embodiment of the subject application;

FIG. 3 is a functional diagram illustrating the device for use in the system for generating a user-adaptable interface presentation on a document processing device according to one embodiment of the subject application;

FIG. 4 is a block diagram illustrating controller hardware for use in the system for generating a user-adaptable interface presentation on a document processing device according to one embodiment of the subject application;

FIG. 5 is a functional diagram illustrating the controller for use in the system for generating a user-adaptable interface presentation on a document processing device according to one embodiment of the subject application;

FIG. 6 is a block diagram illustrating the system for generating a user-adaptable interface presentation on a document processing device according to one embodiment of the subject application;

FIG. 7 is a functional diagram illustrating the system for generating a user-adaptable interface presentation on a document processing device according to one embodiment of the subject application;

FIG. 8 is a flowchart illustrating a method for generating a user-adaptable interface presentation on a document processing device according to one embodiment of the subject application;

FIG. 9 is a flowchart illustrating a method for generating a user-adaptable interface presentation on a document processing device according to one embodiment of the subject application;

FIG. 10 is a flow diagram illustrating user interactions in accordance with the system and method for generating a user-adaptable interface presentation on a document processing device according to one embodiment of the subject application;

FIG. 11 is a sample user-interface display for use with the system and method for generating a user-adaptable interface presentation on a document processing device according to one embodiment of the subject application;

FIG. 12 is a sample user-interface display for use with the system and method for generating a user-adaptable interface presentation on a document processing device according to one embodiment of the subject application;

FIG. 13 is a sample user-interface display for use with the system and method for generating a user-adaptable interface presentation on a document processing device according to one embodiment of the subject application; and

FIG. 14 is a sample user-interface display for use with the system and method for generating a user-adaptable interface presentation on a document processing device according to one embodiment of the subject application.

### DETAILED DESCRIPTION OF THE PREFERRED EMBODIMENT

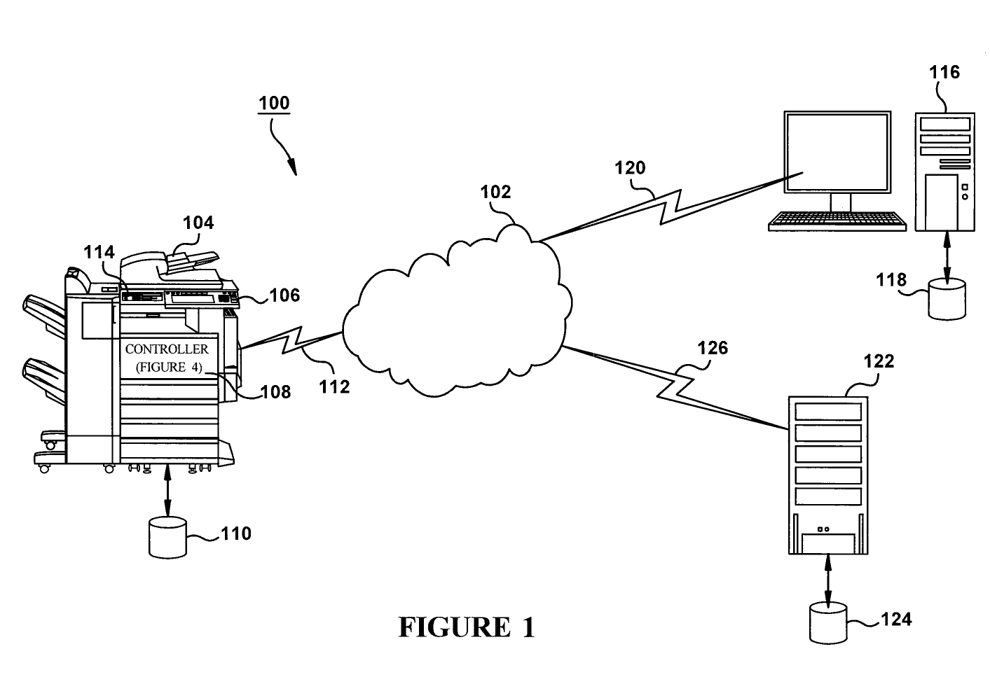

The subject application is directed to a system and method for adaptation of user interface depictions on displays in accordance with a user selection. In particular, the subject application is directed to a system and method for user-customized font size or presentation schemes for document processing devices that allow for improved, subjective user control during document processing activities. More particularly, the subject application is directed to a system and method for generating a user-adaptable interface presentation format on the user interface of an associated document processing device. It will become apparent to those skilled in the art that the system and method described herein are suitably adapted to a plurality of varying electronic fields employing user-adaptable interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of an example system 100 for generating a user-adaptable interface presentation on a document processing device in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

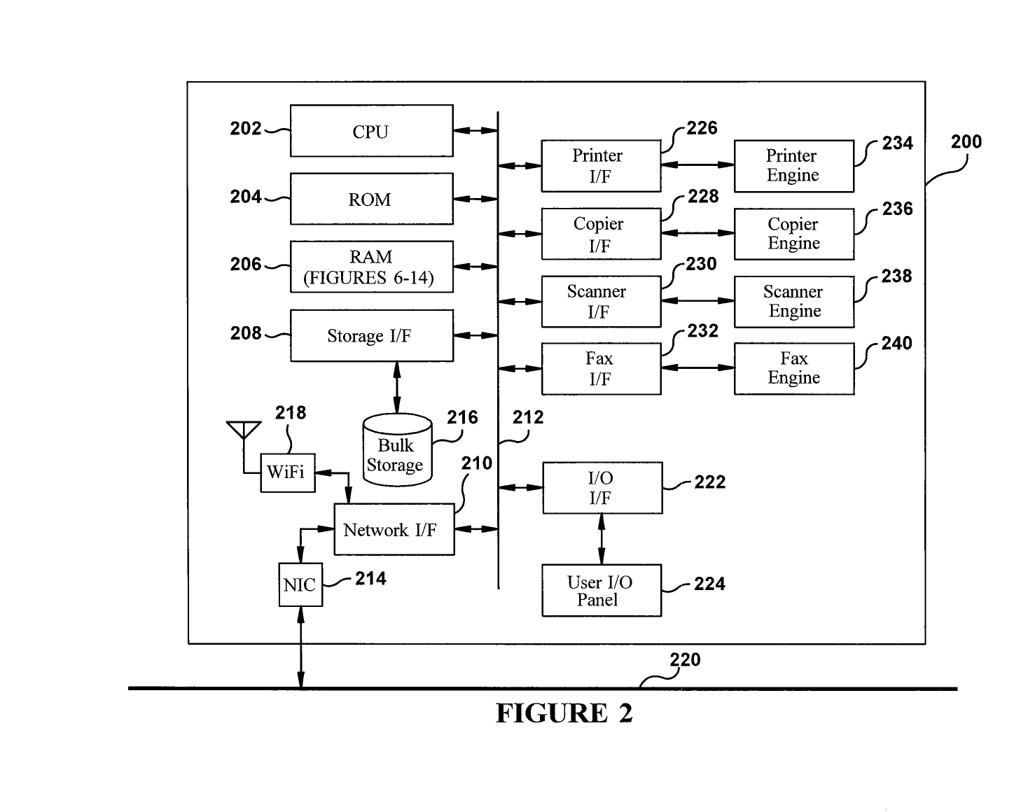

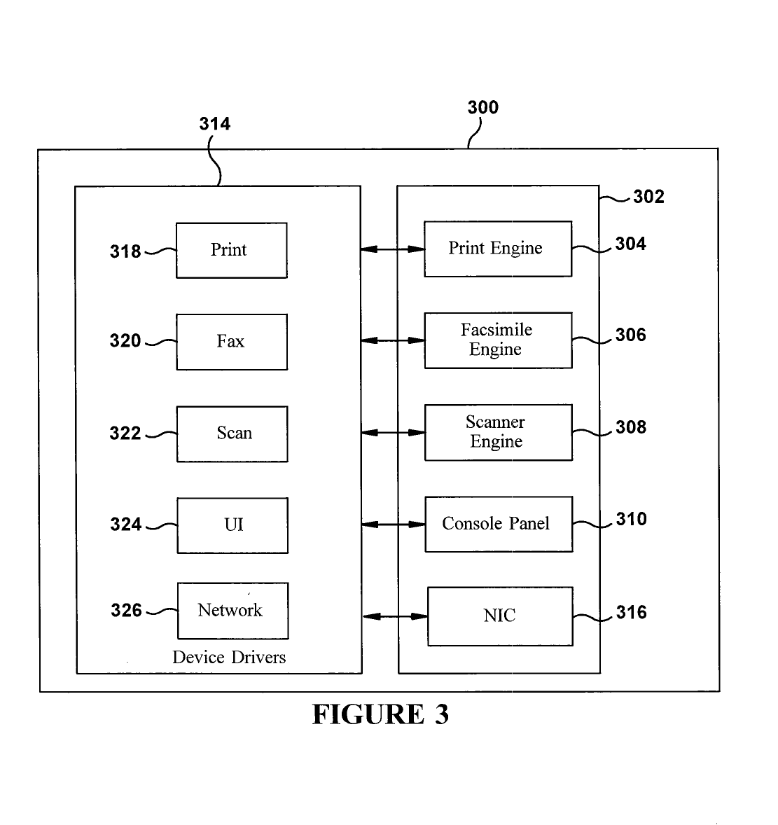

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

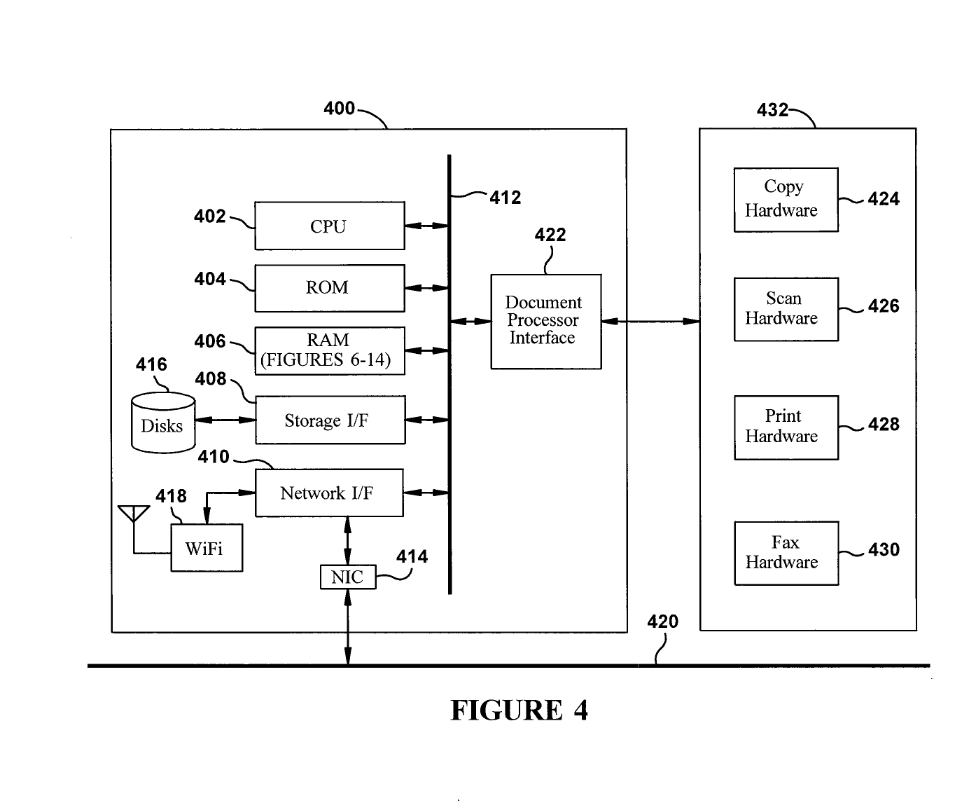

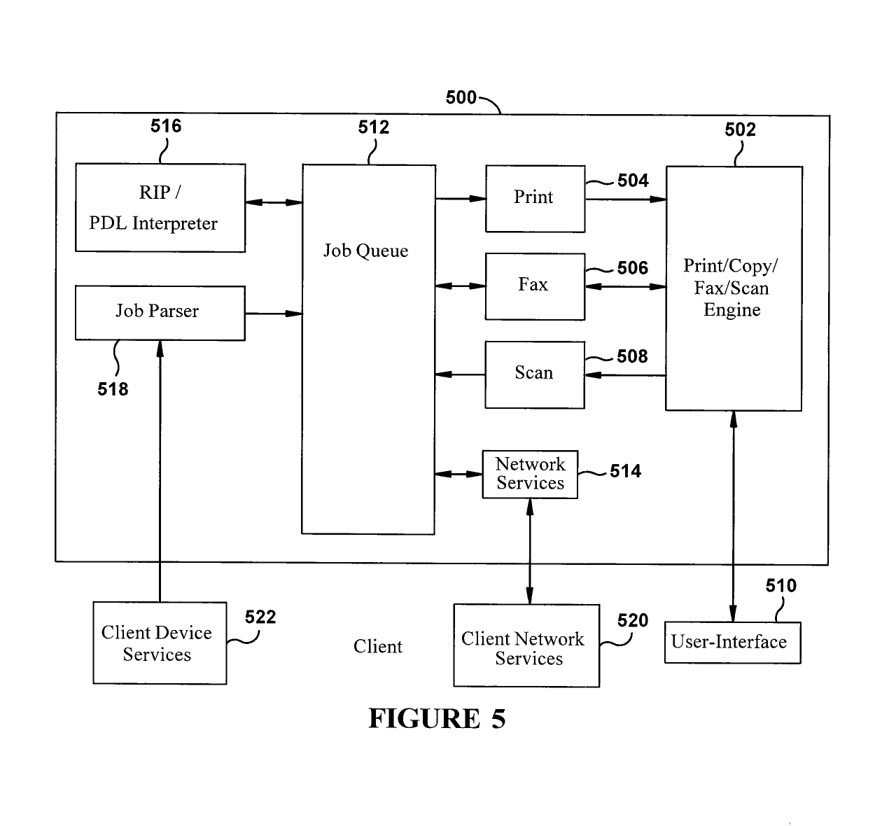

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for generating a user-adaptable interface presentation on a document processing device. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like. The document processing device of FIG. 1 also includes a portable storage device reader 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Also depicted in FIG. 1 is a user device, which is illustrated as a computer workstation 116. The computer workstation 116 is preferably in data communication with the computer network 102 via the communication link 120. It will be appreciated by those skilled in the art that the computer workstation 116 is shown respectively in FIG. 1 as a personal computer for illustration purposes only. As will be understood by those skilled in the art, the computer workstation 116 is representative of any personal computing device known in the art including, for example and without limitation, a laptop computer, a personal computer, a personal data assistant, a web-enabled cellular telephone, a smart phone, a proprietary network device, or other web-enabled electronic device capable of network communications. According to one embodiment of the subject application, the user device 116 includes software, hardware, or a suitable combination thereof configured to interact with the document processing device 104, the server 122, or the like.

The communication link 120 is any suitable channel of data communications known in the art including, but not limited to wireless communications, for example and without limitation, BLUETOOTH, WiMax, 802.11a, 802.11b, 802.11g, 802.11(x), a proprietary communications channel, infrared, optical, the public switched telephone network, or any suitable wireless data transmission system, or wired communications known in the art. Preferably, the user device 116 is suitably adapted to provide or receive document data, job data, user interface data, image data, monitor document processing jobs, employ thin-client interfaces, generate display data, generate output data, or the like, with respect to the document processing device 104, or any other similar device coupled to the computer network 102. According to one embodiment of the subject application, the user device 116 is capable of implementing various graphical user interface applications for interacting with a user, as will be appreciated by those skilled in the art to include a physical keyboard, a soft keyboard via an associated touch screen interface, or a suitable combination thereof.

Communicatively coupled to the computer workstation 116 is a data storage device 118. According to one embodiment of the subject application, the data storage device 118 is any mass storage device, or plurality of such devices, known in the art including, for example and without limitation, magnetic storage drives, a hard disk drive, optical storage devices, flash memory devices, or any suitable combination thereof. In such an embodiment, the data storage device 118 is suitably adapted to store operating systems, document data, preference data, personal information, account information, identification data, regional data, thin client interface data, update software, policy information, and the like. It will be appreciated by those skilled in the art that while illustrated in FIG. 1 as being a separate component of the system 100, the data storage device 118 is capable of being implemented as an internal storage component of the computer workstation 116.

The system 100 illustrated in FIG. 1 further depicts a backend component, shown as the server 122, in data communication with the computer network 102 via a communications link 126. It will be appreciated by those skilled in the art that the server 122 is shown in FIG. 1 as a component of the system 100 for example purposes only, and the subject application is capable of implementation without the use of a separate backend server component. The skilled artisan will appreciate that the server 122 comprises hardware, software, and combinations thereof suitably adapted to provide one or more services, web-based applications, storage options, and the like, to networked devices. In accordance with one example embodiment of the subject application, the server 122 includes various components, implemented as hardware, software, or a combination thereof, for managing retention of secured documents, text data, performing searches, comparisons, maintaining database entries, account information, receiving payment data, retrieval of documents, and the like, which are accessed via the computer network 102.

The communications link 126 is any suitable data communications means known in the art including, but not limited to wireless communications comprising, for example and without limitation BLUETOOTH, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 122 are capable of implementation on any suitable computing device coupled to the computer network 102, e.g. the controller 108, the computer workstation 116, or the like.

Communicatively coupled to the server 122 is the data storage device 124. According to the foregoing example embodiment, the data storage device 124 is any mass storage device, or plurality of such devices, known in the art including, for example and without limitation, magnetic storage drives, a hard disk drive, optical storage devices, flash memory devices, or any suitable combination thereof. In such an embodiment, the data storage device 124 is suitably adapted to store mapping data, document rendering device location data, database entries, software updates, secured electronic documents, text data, data strings, account information, policy information, and the like. It will be appreciated by those skilled in the art that while illustrated in FIG. 1 as being a separate component of the system 100, the data storage device 124 is capable of being implemented as an internal storage component of the server 122, or the like, such as, for example and without limitation, an internal hard disk drive, or the like.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document processing device 104, which includes the controller 400 of FIG. 4, (shown in FIG. 1 as the controller 108) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

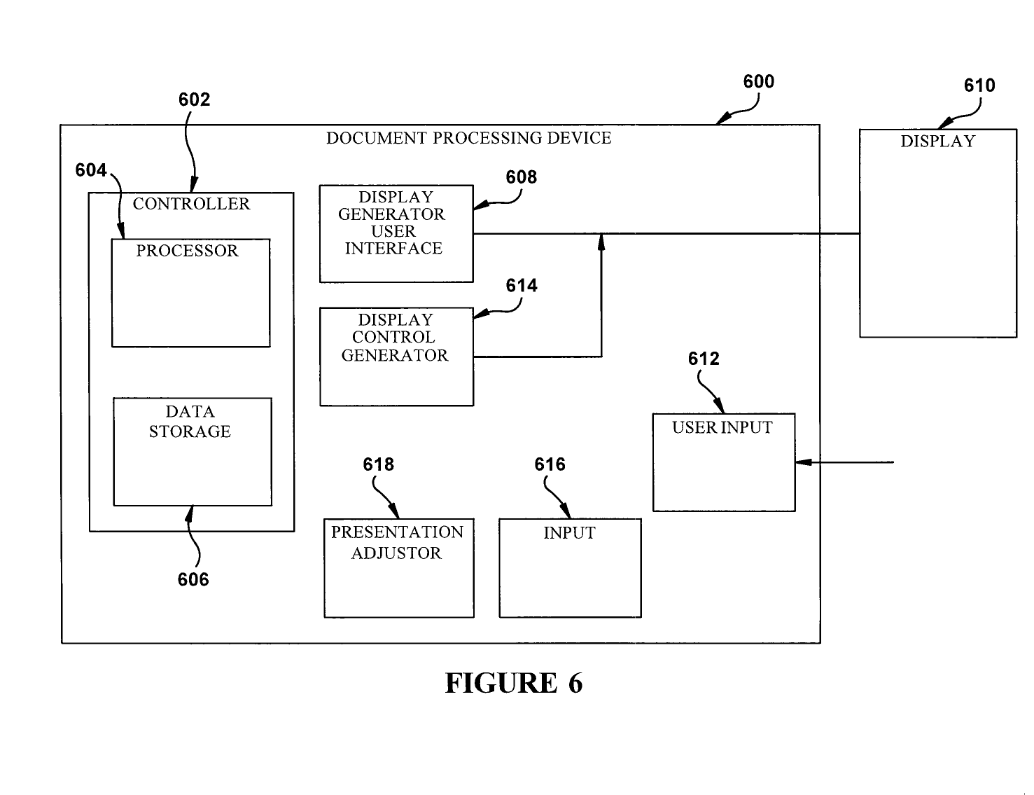

Referring now to FIG. 6, illustrated is a block diagram of a document processing device 600 having a user-adaptable interface presentation in accordance with one embodiment of the subject application. The document processing device 600 is preferably operable in conjunction with an integrated controller 602 that includes a processor 604 and an associated data storage 606. The document processing device 600 also includes a display generator user interface 608 that is configured to, on a display 610, a visual output associated with the operation and the status of the document processing device 600. The document processing device 600 also incorporates a user input 612 that is configured to receive user-specified instructions. These user-specified instructions preferably correspond to a display for operation of the document processing device 600.

Also included with the document processing device 600 is a display control generator 614 that is operable to generate, on the display 610, one or more visual indicators that correspond to a user-selectable display attribute. In addition, the document processing device 600 includes an input 616 and a presentation adjustor 618. Preferably, the input 616 is configured to receive user-specified display modification instructions that correspond to a desired modification of the visual output in accordance with the displayed visual indicator. The presentation adjustor 618 operates to alter the visual output based upon the received user-specified display modification instructions.

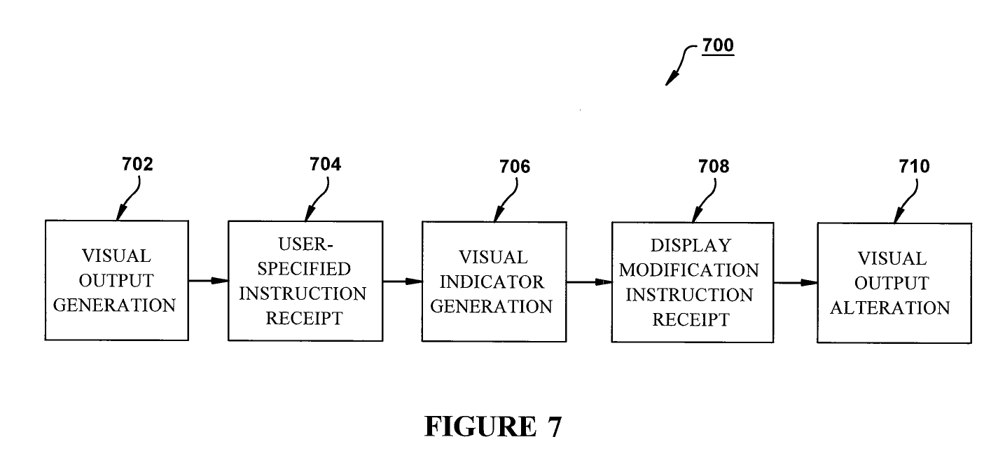

Turning now to FIG. 7, illustrated is a functional diagram of a system 700 for generating a user-adaptable interface presentation on a document processing device in accordance with one embodiment of the subject application. As shown in FIG. 7, visual output generation 702 associated with the operation and the status of a document processing device is first performed on a display of the document processing device that is operable in conjunction with an integrated controller that includes a processor and an associated data storage. User-specified instruction receipt 704 then occurs of instructions that correspond to a display for operating the document processing device.

Visual indicator generation 706 is then performed on the display of one or more visual indicators that correspond to a user-selectable display attribute. Display modification instruction receipt 708 then occurs of user-specified modification instructions for modifying the visual output in accordance with the displayed visual indicator. Visual output alteration 710 is then performed of the visual output based upon the received user-specified display modification instructions.

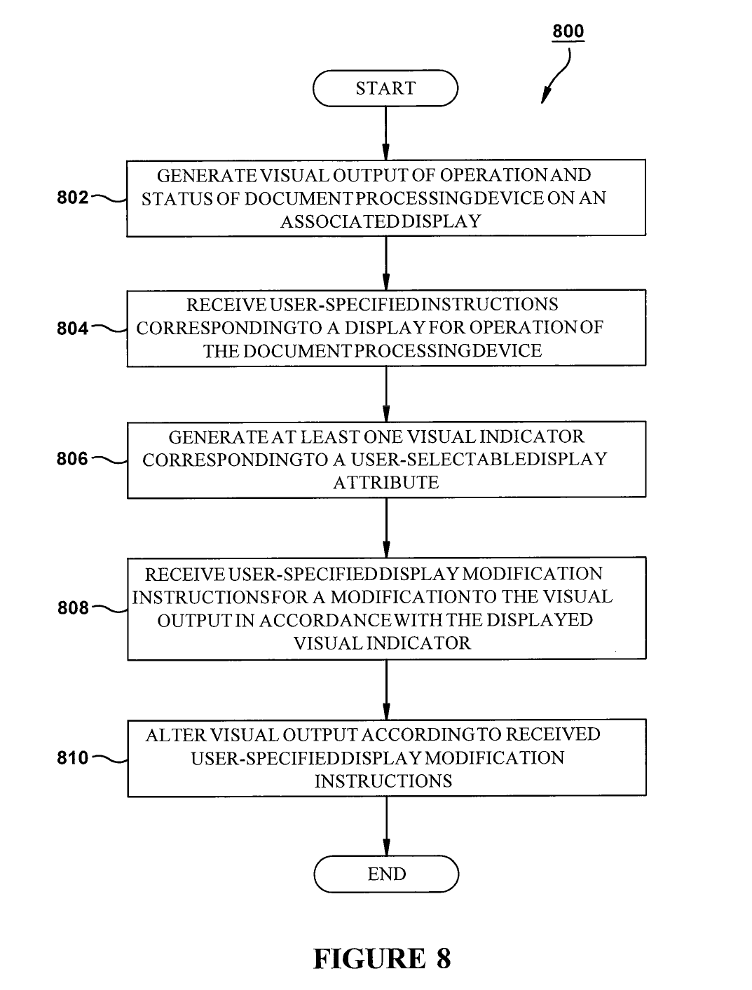

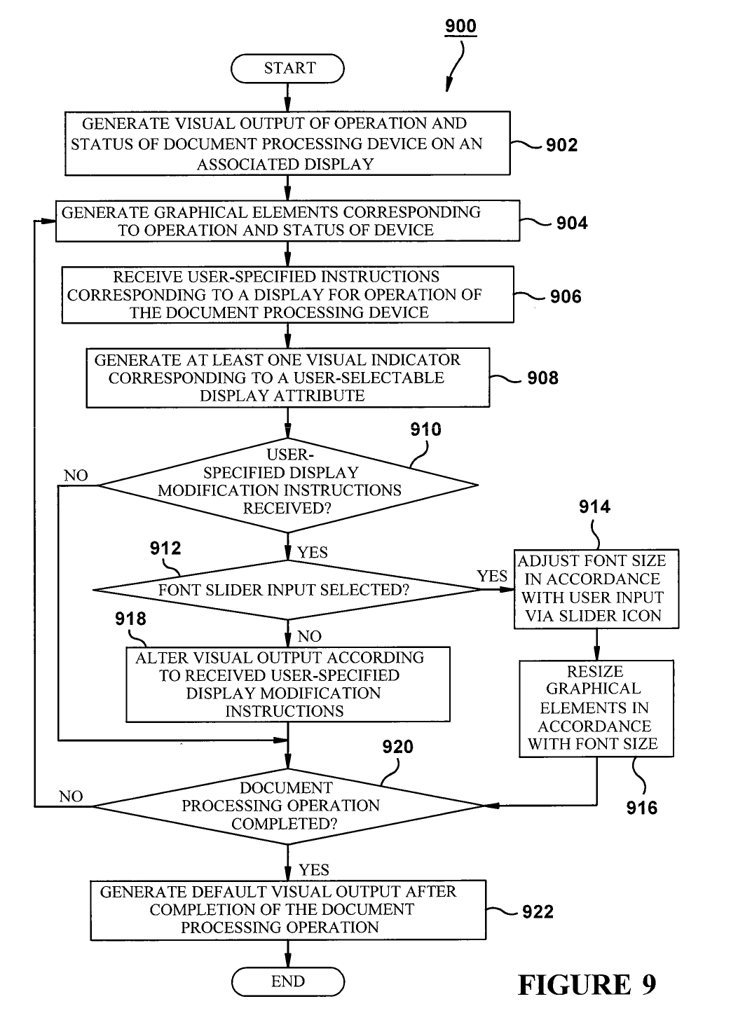

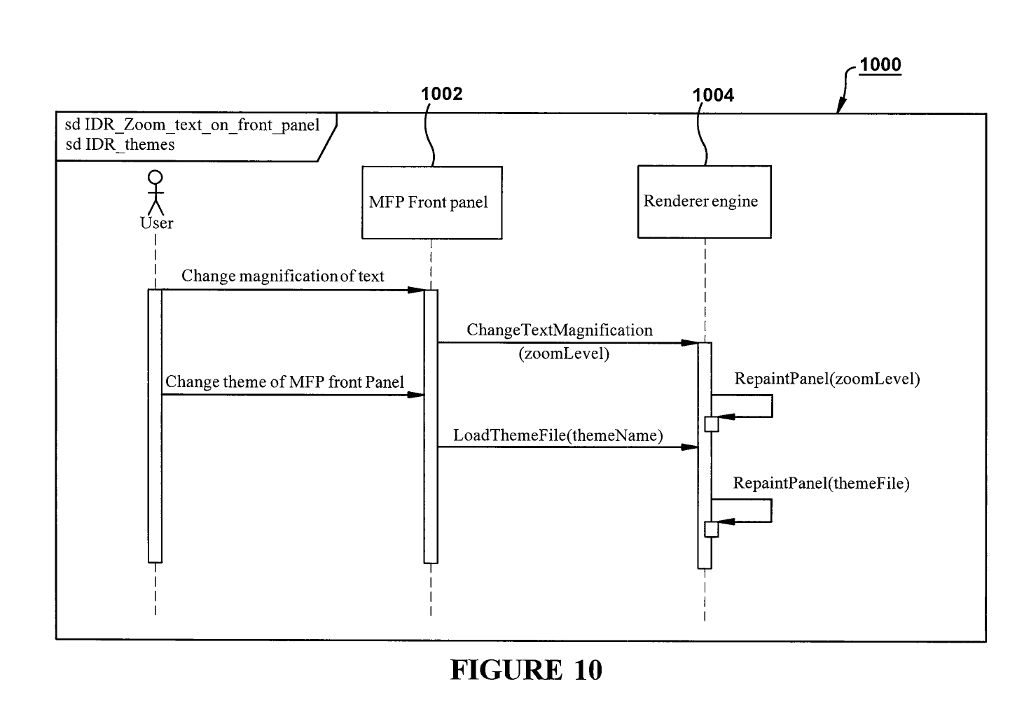

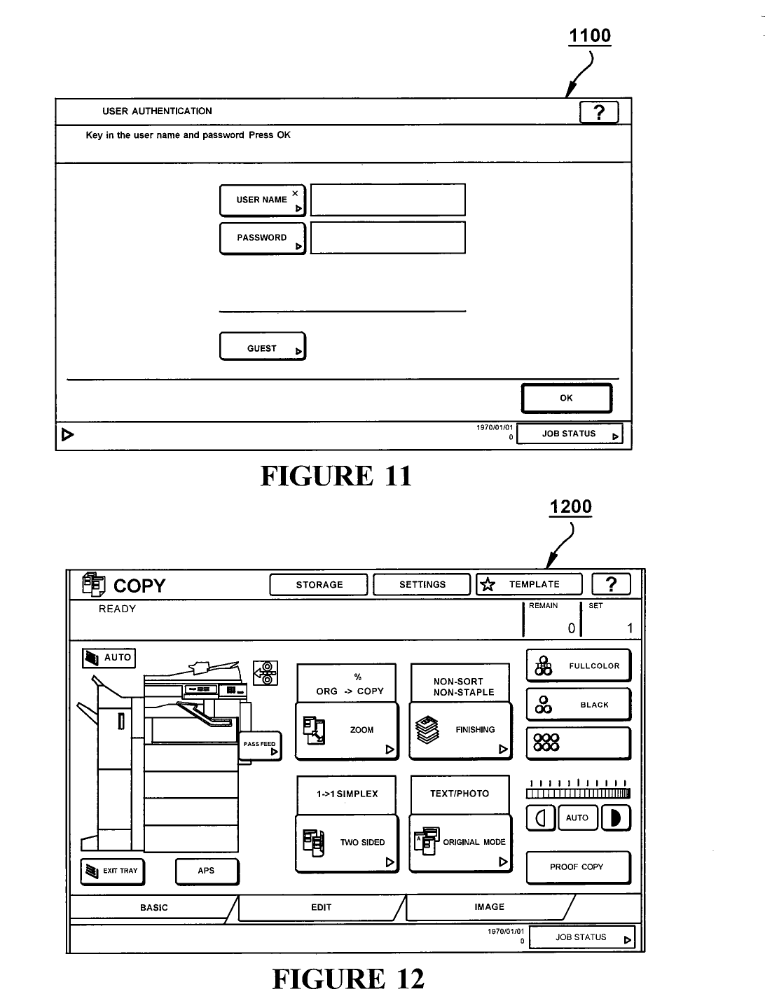

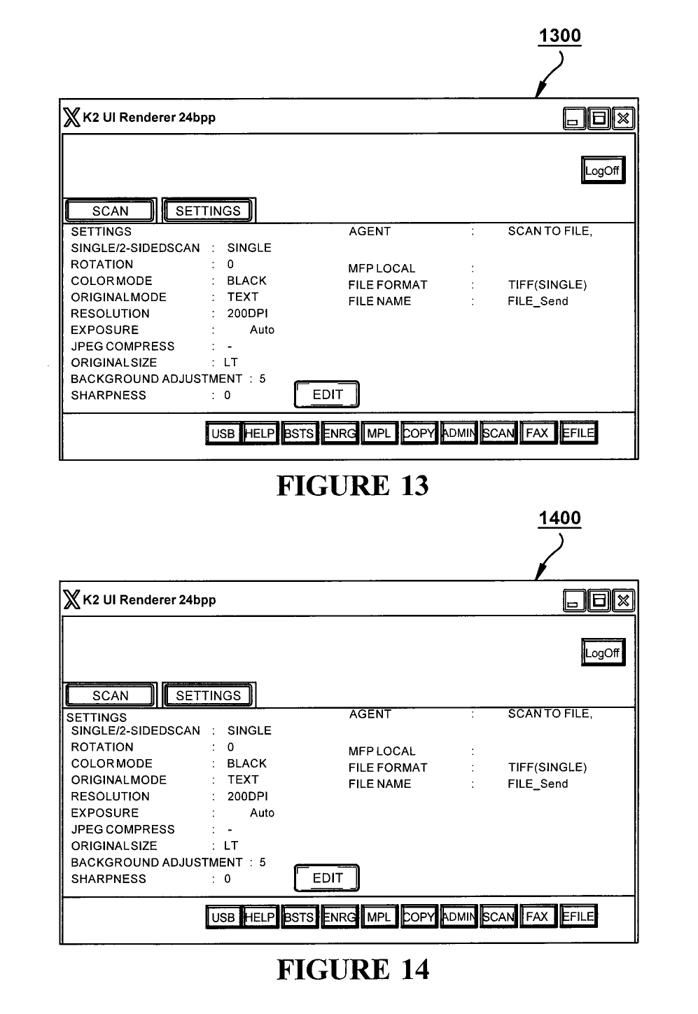

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9, as well as the example illustrations of the embodiments depicted in FIG. 10, FIG. 11, FIG. 12, and FIG. 13. Turning now to FIG. 8, there is shown a flowchart 800 illustrating a method for generating a user-adaptable interface presentation on a document processing device in accordance with one embodiment of the subject application. Beginning at step 802, a visual output associated with the operation and the status of the document processing device is generated on a display of a document processing device. Preferably, the display is operable in conjunction with an integrated controller having a processor and associated data storage.

At step 804, user-specified instructions corresponding to a display for operation of the document processing device are received. Next, at least one visual indicator corresponding to a user-selectable display attribute is generated on the display at step 806. At step 808, user-specified display modification instructions corresponding to a desired modification to the visual output in accordance with the displayed visual indicator are received. Thereafter, at step 810, the visual output is altered in accordance with the received user-specified display modification instructions.

Referring now to FIG. 9, there is depicted a flowchart 900 illustrating a method for document processing workflow in accordance with one example embodiment of the subject application. The methodology of FIG. 9 begins at step 902, whereupon a visual output is generated on the user interface 106 of the document processing device 104 corresponding to the operation and status of the document processing device 104. Preferably, the user interface 106, i.e. the display, is configured to be operable in conjunction with the controller 108. In accordance with one embodiment of the subject application, the visual output includes, for example and without limitation, alphanumeric characters, color scheme, icons, and the like.

Graphical elements corresponding to the operation and the status of the document processing device 104 are then generated on the display of the user interface 106 at step 904. It will be appreciated by those skilled in the art that such elements include, for example and without limitation, icons representative of document processing operations, finishing options, paper jams, paper amounts, toner levels, and the like. Instructions are then received from an associated user at step 906 that correspond to a display for operation of the document processing device 104. The skilled artisan will appreciate that the instructions are capable of including, for example and without limitation, a copy operation, a facsimile operation, a scanning operation, or the like, as well as additional sub-operations associated therewith, e.g. duplex, electronic mail, storage, finishing options, etc.

At step 908, one or more visual indicators are generated on the display of the user interface 106 corresponding to a user-selectable display attribute. In accordance with one embodiment of the subject application, user-selectable display attributes include, for example and without limitation, a desired theme (color), a magnification level (zoom), or the like. It will be appreciated by those skilled in the art that the visual indicators include, for example and without limitation, a slider bar corresponding to a resizing function, a style/theme icon, a color icon, a font slider size icon, and other like indicia.

A determination is then made at step 910 whether any user-specified display modification instructions corresponding to a desired modification to the visual output in accordance with the displayed visual indicator have been received from the associated user via the user interface 106. Upon a determination at step 910 that user-specified display modification instructions have been received, flow progresses to step 912, whereupon a determination is made whether the user has provided input via the font slider so as to resize the displayed font. That is, whether instructions relative to font size for the alphanumeric characters have been received via user manipulation of the slider icon on the display of the user interface 106. Upon a positive determination at step 912, flow proceeds to step 914 whereupon the font size is adjusted in accordance with the user manipulation of the slider icon. At step 916, the graphical elements displayed on the user interface 106 of the document processing device 104 are also resized in accordance with font size as modified at step 914. Operations then progress to step 920, as discussed below.

Returning to step 910, upon a determination that instructions have not been received relative to modification of the display on the user interface 106, flow proceeds to step 920, whereupon a determination is made whether the document processing operation associated with the user interactions with the document processing device 104 has been completed. In the event that the operation of the document processing device 104 has not been completed, i.e. the user has not logged off of the device 104, flow returns to step 904. Upon a determination at step 920 that the document processing operation has been completed, flow proceeds to step 922, whereupon a default visual output is generated on the display of the user interface 106. The skilled artisan will appreciate that such default visual output includes, for example and without limitation, a manufacturer or service provider standard color scheme and font size, standard login screen, and the like. In accordance with one embodiment of the subject application, suitable default settings of the user interface 106 are capable of being retrieved from the user device 116, the server 122, the data storage 110, or the like.

Returning to step 912, upon a determination that the font slider icon has not been selected, flow proceeds to step 918, whereupon the visual output is altered in accordance with the received user-specified display modification instructions. For example, the color of icons, the style or theme of the display, or the like are altered in accordance with the received instructions. It will be appreciated by those skilled in the art that the controller 108 or other suitable component associated with the document processing device 104 is suitably adapted to facilitate this adjustment of the display associated with the user interface 106. In accordance with one embodiment of the subject application, suitable user-specified display modifications are capable of being received via the computer network 102 from the user device 116, the server 122, or the like. After modification, flow proceeds to step 920 for a determination of whether the document processing operation has been completed. Following a positive determination at step 920, operations progress to step 922, whereupon the default display of the user interface 106 is reinstituted and the methodology of FIG. 9 terminates.

Turning now to FIG. 10, there is shown a diagram 1000 illustrating an example of the system and method for generating a user-adaptable interface presentation on a document processing device implemented in accordance with one embodiment of the subject application. The diagram 1000 suitably illustrates user interactions with the user interface 106 of the document processing device 104, shown as the MFP front panel 1002 of FIG. 10. From this front panel 1002, the user is able to alter, for example and without limitation, the magnification of text, the theme of the user interface 106, or the like. Once a change is made at the front panel 1002 by the user, the change is submitted to the renderer engine 1004 (e.g. the controller 108) for changes to the graphical user interface displayed by the document processing device 104. Thereafter, the front panel 1002 (user interface 106) is ‘repainted’ or ‘reloaded’ with the magnified text, the new theme, and the like. Such interactions are better understood via the example illustrations of screens 1100-1400 associated with the user interface 106 of the document processing device 104.

FIG. 11 depicts a sample login display 1100 illustrating one example of a user-adaptable interface presentation on a document processing device implemented in accordance with one embodiment of the subject application. FIG. 12 shows the first screen 1200 displayed on the user interface 106 of the document processing device 104 after login via FIG. 11, which is capable of modification in accordance with the system and method for user-adaptable interface presentation on a document processing device. Referring now to FIG. 13, there is shown a sample screen 1300 illustrating a gray/white theme in accordance with one embodiment of the subject application. FIG. 14 depicts another sample screen 1400 having a different theme, e.g. white background, alternate colors (not shown) theme in accordance with one embodiment of the subject application. According to one embodiment of the subject application, after logging off, the user interface 106 returns to a default display of theme and text size, as will be appreciated by those skilled in the art.

Preferably, the subject application enables the associated user to customize areas of the graphical user interface that is displayed via the user interface 106, e.g. backgrounds, text, buttons, borders, and other graphical components. The skilled artisan will appreciate that such ‘skins’ are capable of being used to change the default background of all windows or change the font for all text boxes in the graphical user interface. Preferably, these skins are overridden if the same property is supplied in individual controls. Accordingly, the system and method of the subject application enable the reduction of setting widget properties in the layout XML and thus allow design teams to easily change the color schema and fonts.

A sample theme file can describe the default properties of all widgets (as shown in FIG. 14):

```
<?xml version=“1.0” encoding=“utf-8” ?>
<Theme description=“green on white”>
  <window>
      <border>black</border>
    <backColor>white</backColor>
  </window>
  <text>
      <foreColor>green</foreColor>
    <font bold=“false” italics=“false” size=“12”>EBX</font>
  </text>
  <button>
      <color>white</color>
    <selectedColor>black</selectedColor>
  <button>
</Theme>
```

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document processing device having a user-adaptable interface presentation comprising:
a document processing device operable in conjunction with an integrated controller having a processor and associated data storage;
a display generator user interface operable to generate, on a display, a visual output associated with operation and status of the document processing device;
a user input operable to receive user-specified instructions corresponding to a display for operation of the document processing device;
a display control generator operable to generate, on the display, at least one visual indicator corresponding to a user-selectable display attribute;
an input operable to receive user-specified display modification instructions corresponding to a desired modification to the visual output in accordance with the displayed visual indicator; and
a presentation adjustor operable to alter the visual output in accordance with received user-specified display modification instructions.

2. The system of claim 1 wherein the display generator is further operable to generate the visual output inclusive of alphanumeric characters, and wherein the display modification instructions include instructions relative to font size for the alphanumeric characters corresponding to the display modification instructions.

3. The system of claim 2 wherein the visual indicator is comprised of a depiction of a slider bar, a position of which corresponds to the font size.

4. The system of claim 1 wherein the display generator is further operable to generate the visual output inclusive of a color scheme, and wherein the display modification instructions include instructions relative to a user-selected color scheme.

5. The system of claim 4 wherein the visual indicator is comprised of indicia corresponding to at least one alternative color scheme.

6. The system of claim 2 wherein the display generator is further operable to generate graphical elements corresponding to the operation and status of the document processing device, and wherein the display adjustor is further operable to resize the graphical elements in accordance with font size.

7. The system of claim 1 wherein the presentation adjustor is further operable to return to a default visual output after completion of the document processing operation.

8. A method for generating a user-adaptable interface presentation on a document processing device comprising:
generating, on a display of a document processing device operable in conjunction with an integrated controller having a processor and associated data storage, a visual output associated with operation and status of the document processing device;
receiving user-specified instructions corresponding to a display for operation of the document processing device;
generating, on the display, at least one visual indicator corresponding to a user-selectable display attribute;
receiving user-specified display modification instructions corresponding to a desired modification to the visual output in accordance with the displayed visual indicator; and
altering the visual output in accordance with received user-specified display modification instructions.

9. The method of claim 8 further comprising generating the visual output inclusive of alphanumeric characters, and wherein the display modification instructions include instructions relative to font size for the alphanumeric characters corresponding to the display modification instructions.

10. The method of claim 9 wherein the visual indicator is comprised of a depiction of a slider bar, a position of which corresponds to the font size.

11. The method of claim 8 further comprising generating the visual output inclusive of a color scheme, and wherein the display modification instructions include instructions relative to a user-selected color scheme.

12. The method of claim 11 wherein the visual indicator is comprised of indicia corresponding to at least one alternative color scheme.

13. The method of claim 9 further comprising:
generating graphical elements corresponding to the operation and status of the document processing device; and
resizing the graphical elements in accordance with font size.

14. The method of claim 8 further comprising generating a default visual output after completion of the document processing operation.

15. A system for generating a user-adaptable interface presentation on a document processing device comprising:
means adapted for generating, on a display of a document processing device operable in conjunction with an integrated controller having a processor and associated data storage, a visual output associated with operation and status of the document processing device;
means adapted for receiving user-specified instructions corresponding to a display for operation of the document processing device;
means adapted for generating, on the display, at least one visual indicator corresponding to a user-selectable display attribute;
means adapted for receiving user-specified display modification instructions corresponding to a desired modification to the visual output in accordance with the displayed visual indicator; and
means adapted for altering the visual output in accordance with received user-specified display modification instructions.

16. The system of claim 15 further comprising means adapted for generating the visual output inclusive of alphanumeric characters, and wherein the display modification instructions include instructions relative to font size for the alphanumeric characters corresponding to the display modification instructions.

17. The system of claim 16 wherein the visual indicator is comprised of a depiction of a slider bar, a position of which corresponds to the font size.

18. The system of claim 15 further comprising means adapted for generating the visual output inclusive of a color scheme, and wherein the display modification instructions include instructions relative to a user-selected color scheme.

19. The system of claim 18 wherein the visual indicator is comprised of indicia corresponding to at least one alternative color scheme.

20. The system of claim 16 further comprising:
means adapted for generating graphical elements corresponding to the operation and status of the document processing device; and
means adapted for resizing the graphical elements in accordance with font size.

21. The system of claim 15 further comprising means adapted for generating a default visual output after completion of the document processing operation.
